(19) United States
(12) Patent Application Publication
(10) Pub. No.: US 2020/0001699 A1
(43) Pub. Date: Jan. 2, 2020

(54) PARALLEL HYBRID ELECTRIC VEHICLE (HEV) POWERTRAIN ASSEMBLY WITH PARTIALLY OVERLAPPING TORQUE CONVERTER AND MOTOR-GENERATOR UNIT (MGU)

(71) Applicant: GM Global Technology Operations LLC, Detroit, MI (US)

(72) Inventors: Shawn H. Swales, Canton, MI (US); Goro Tamai, Bloomfield Hills, MI (US)

(21) Appl. No.: 16/022,834

(22) Filed: Jun. 29, 2018

(51) Int. Cl. B60K 6/48; B60K 6/387; B60K 6/26; B60K 6/40; B60L 15/20; H02K 7/00

(52) U.S. Cl. CPC B60K 6/48; B60K 6/387; H02K 7/006; B60K 6/40; B60L 15/20; B60K 6/26

(57) ABSTRACT

A parallel (P2) hybrid electric vehicle (HEV) powertrain assembly includes a torque converter and a motor-generator unit (MGU). The parallel hybrid electric vehicle (HEV) powertrain assembly can be equipped in a rear wheel drive (RWD) powertrain architecture, or in another architecture arrangement of the powertrain. The torque converter includes an impeller and a turbine. The motor-generator unit includes a rotor and a stator. The torque converter and the motor-generator unit exhibit an at least partially axially overlapping relationship with respect to each other.

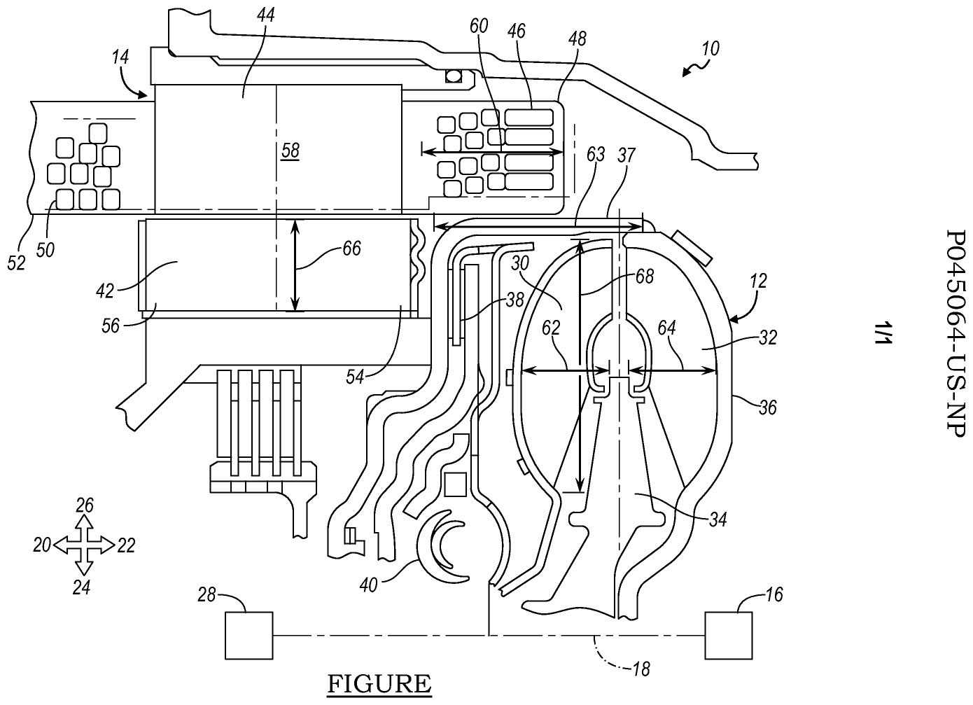

### INTRODUCTION

The present disclosure relates to hybrid electric vehicle (HEV) powertrain architectures, and more particularly relates to parallel (P2) hybrid electric vehicle powertrain architectures.

A hybrid electric vehicle powertrain architecture of an automobile is commonly equipped with a motor-generator unit (MGU) that can serve as both a generator and a motor, and an internal combustion engine that can provide power to drive wheels of the larger automobile. Further, automatic transmissions are often equipped with a torque converter that utilizes fluid to transfer torque from the internal combustion engine to a downstream transmission. Packaging in a hybrid electric vehicle powertrain architecture can be demanding and, in some cases, even mostly inflexible, and hence can dictate the selected components and their arrangement within the powertrain architecture.

### SUMMARY

In an embodiment, a parallel hybrid electric vehicle (HEV) powertrain assembly may include a torque converter and a motor-generator unit (MGU). The torque converter includes an impeller, a turbine, and a cover. The motor-generator unit includes a rotor and a stator. The stator has wire windings with a first set of end-turns at one end of the stator. In installation of the parallel hybrid electric vehicle powertrain assembly, the first set of end-turns of the stator is situated at a location that is radially outboard of the impeller of the torque converter. The first set of end-turns of the stator is further situated at a location that is radially outboard of the turbine of the torque converter. A first axial extent of the first set of end-turns of the stator exhibits an at least partially axially overlapping relationship with a second axial extent of the cover of the torque converter.

In an embodiment, the first axial extent of the first set of end-turns of the stator exhibits a partially or more axially overlapping relationship with a third axial extent of the impeller of the torque converter.

In an embodiment, a fourth axial extent of the turbine of the torque converter lacks an axially overlapping relationship with the first axial extent of the first set of end-turns of the stator.

In an embodiment, the stator has a central region. The central region is situated axially-inward of the first set of end-turns of the stator, and is situated axially-outward of a second set of end-turns of the stator. The central region lacks an axially overlapping relationship with the third axial extent of the impeller of the torque converter.

In an embodiment, a first radial extent of the impeller of the torque converter exhibits a radially overlapping relationship with a second radial extent of the rotor of the motor-generator unit.

In an embodiment, the rotor lacks an axially overlapping relationship with the third axial extent of the impeller of the torque converter.

In an embodiment, the torque converter includes a clutch. The clutch exhibits an axially overlapping relationship with the first axial extent of the first set of end-turns of the stator.

In an embodiment, the location of the first set of end-turns of the stator is radially outboard of the clutch.

In an embodiment, the location of the first set of end-turns of the stator is radially outboard of the cover of the torque converter.

In an embodiment, a parallel hybrid electric vehicle (HEV) powertrain assembly may include a torque converter and a motor-generator unit (MGU). The torque converter includes an impeller. The motor-generator unit includes a stator. The stator has wire windings with a first set of end-turns at one end of the stator, and with a second set of end-turns at an opposite end of the stator. The stator has a central region. The central region is situated axially-inward of the first set of end-turns, and is situated axially-outward of the second set of end-turns. In installation of the parallel hybrid electric vehicle powertrain assembly, a first axial extent of the first set of end-turns of the stator exhibits an at least partially axially overlapping relationship with a second axial extent of the impeller of the torque converter. The central region of the stator lacks an axially overlapping relationship with the second axial extent of the impeller of the torque converter.

In an embodiment, the first set of end-turns of the stator is situated at a location that is radially outboard of the impeller of the torque converter.

In an embodiment, a third axial extent of a turbine of the torque converter lacks an axially overlapping relationship with the first axial extent of the first set of end-turns of the stator.

In an embodiment, a first radial extent of the impeller of the torque converter exhibits a radially overlapping relationship with a second radial extent of a rotor of the motor-generator unit.

In an embodiment, a rotor of the motor-generator unit lacks an axially overlapping relationship with the second axial extent of the impeller of the torque converter.

In an embodiment, the torque converter includes a clutch. The clutch exhibits an axially overlapping relationship with the first axial extent of the first set of end-turns of the stator.

In an embodiment, a parallel hybrid electric vehicle (HEV) powertrain assembly may include a torque converter and a motor-generator unit (MGU). The torque converter includes an impeller. The motor-generator unit includes a rotor and a stator. The stator has wire windings with a first set of end-turns at one end of the stator. In installation of the parallel hybrid electric vehicle powertrain assembly, a first axial extent of the first set of end-turns of the stator exhibits an at least partially axially overlapping relationship with a second axial extent of the impeller of the torque converter. The rotor lacks an axially overlapping relationship with the second axial extent of the impeller of the torque converter.

In an embodiment, the first set of end-turns of the stator is situated at a location that is radially outboard of the impeller of the torque converter.

In an embodiment, a third axial extent of a turbine of the torque converter lacks an axially overlapping relationship with the first axial extent of the first set of end-turns of the stator.

In an embodiment, the torque converter includes a clutch. The clutch exhibits an axially overlapping relationship with the first axial extent of the first set of end-turns of the stator.

In an embodiment, the location of the first set of end-turns of the stator is radially outboard of the clutch.

### BRIEF DESCRIPTION OF THE DRAWING

One or more aspects of the disclosure will hereinafter be described in conjunction with the appended drawing, wherein like designations denote like elements, and wherein:

The FIGURE presents a schematic depiction of an embodiment of a parallel hybrid electric vehicle (HEV) powertrain assembly.

### DETAILED DESCRIPTION

Referring to the drawing, a parallel (P2) hybrid electric vehicle (HEV) powertrain architecture and assembly 10 (hereafter, HEV powertrain assembly) is designed and constructed to satisfy the packaging demands that arise when equipping the HEV powertrain assembly 10 with a torque converter 12 and a motor-generator unit (MGU) 14. Such packaging demands can be particularly challenging when arranging powertrain components in an axial configuration relative to one another and within a confined overall axial length of the HEV powertrain assembly 10, especially when the HEV powertrain assembly 10 is furnished with an internal combustion engine 16 of increased axial length such as an eight-cylinder “V” configuration engine (i.e., V8 engine). The HEV powertrain assembly 10 is intended to fulfill these demands by, among other possibly suitable configurations, arranging the torque converter 12 and the motor-generator unit 14 to exhibit a partially axially overlapping relationship with respect to each other. The torque converter 12 and motor-generator unit 14 are arranged without compromising the effectiveness and efficiencies of the components, and without exacerbating bending issues commonly experienced in the powertrain, as has been observed in previously-known arrangements. The accompanying vehicle can ultimately have improved drivability. The HEV powertrain assembly 10 is described below in the context of an automotive application, yet could be equipped in non-automotive applications as well.

As set forth herein, the terms axial and radial and their grammatical variations are used with reference to a longitudinal axis 18 of the HEV powertrain assembly 10 such that the following directions are presented in the FIGURE: an axial inward direction 20, an axial outward direction 22, a radial inboard direction 24, and a radial outboard direction 26.

The HEV powertrain assembly 10 can have different designs, constructions, and components in different embodiments depending upon—among other possible factors—the designs and constructions and components of upstream and downstream portions of the associated powertrain in which the HEV powertrain assembly 10 is equipped. The HEV powertrain assembly 10 can be employed in a rear wheel drive (RWD) powertrain architecture, or can be employed in another kind of powertrain architecture. In the embodiment of the FIGURE, the HEV powertrain assembly 10 includes the torque converter 12 and the motor-generator unit 14.

The torque converter 12 transfers torque from the internal combustion engine 16 and to a vehicle transmission 28. The internal combustion engine 16 and/or vehicle transmission 28 can constitute additional components of the HEV powertrain assembly 10 in various embodiments. The torque converter 12 receives rotational drive input from the internal combustion engine 16 and transmits rotational drive output downstream to the vehicle transmission 28. The torque converter 12 can take different forms in different embodiments. In the embodiment presented by the FIGURE, the torque converter 12 primarily includes a pump or impeller 30, a turbine 32, a stator 34, a shell or housing 36, a cover 37, a clutch 38, and a damper 40; of course, the torque converter 12 includes other components than those presented here, and could include different components than those presented here. In general, skilled artisans will appreciate how the torque converter 12 operates and how its components work together to carry out its torque-transferring functionality, and therefore a detailed description of such is not presented here.

The motor-generator unit 14 serves as both a generator and a motor amid use of the HEV powertrain assembly 10. The motor-generator unit 14 can take different forms in different embodiments. In the embodiment of the FIGURE, the motor-generator unit 14 includes a rotor 42 and a stator 44. The rotor 42 constitutes the rotating member of the motor-generator unit 14. Though not specifically depicted, the rotor 42 carries one or more permanent magnets. The stator 38 constitutes the non-rotating member of the motor-generator unit 14. Relative to the rotor 42, the stator 44 is positioned radially outboard thereof. The stator 44 is made up of, among other components, copper wire windings with a first set of end-turns 46 at a first end 48 of the stator 44, and with a second set of end-turns 50 at a second end 52 of the stator 44. The first and second ends 48, 50 are situated opposite each other. As illustrated in the FIGURE, the first set of end-turns 46 axially overhangs a first end 54 of the rotor 42, and the second set of end-turns 50 axially overhangs a second end 56 of the rotor 42. Further, the stator 44 has a central region 58 situated axially-inward of the first set of end-turns 46, and situated axially-outward of the second set of end-turns 50.

As mentioned, packaging demands can be particularly challenging when equipping the HEV powertrain assembly 10 with the torque converter 12 and with the motor-generator unit 14. Moreover, the packaging demands can deepen when arranging components of the HEV powertrain assembly 10 in an axial configuration relative to one another and within a confined overall axial length of the HEV powertrain assembly 10. Confined overall axial lengths in automotive powertrain applications can oftentimes be inflexible. What is more, internal combustion engines of increased axial lengths, such as V8 engines, heighten the challenges. Previous efforts have involved arrangements unlike those described herein. Stacking the components axially in spaced axial relation has been shown to add to the overall axial length of the accompanying powertrain by a somewhat considerable amount—in some instances, by more than one-hundred millimeters (mm)—which can be unsuitable in certain applications. One previous approach, in particular, involved fully axially overlapping a torque converter with both a rotor and a stator of an MGU in which the torque converter was positioned radially inboard of both the rotor and the stator. While this approach may be suitable in certain circumstances, it was observed that axially overlapping these components fully could cause a diminishment in performance of the components, and could worsen powertrain bending issues experienced amid use.

The HEV powertrain assembly 10 is designed and constructed to resolve these challenges and hence satisfy the packaging demands encountered when the HEV powertrain assembly 10 is equipped with both of the torque converter 12 and the motor-generator unit 14. Any addition to the overall axial length by the HEV powertrain assembly 10 is minimized, and the HEV powertrain assembly 10 is suitable for use with an internal combustion engine of increased axial length such as a V8 engine. Furthermore, the torque converter 12 and motor-generator unit 14 are arranged in the HEV powertrain assembly 10 in a manner that maintains their performance, effectiveness, and efficiencies, and that does not aggravate powertrain bending concerns.

The designs and constructions of the HEV powertrain assembly 10 set forth here—alone or in combination with one another—is thought to bring about these advancements. In assembly and installation, different embodiments of the HEV powertrain assembly 10 can include one or more, a combination, or all of the following arrangement relationships. With reference once again to the embodiment of the FIGURE, the torque converter 12 and motor-generator unit 14 are arranged relative to each other with a partial axial overlapping relationship. A first axial extent 60 of the first set of end-turns 46 overlaps partially or more with a second axial extent 62 of the impeller 30 in the axial direction. The overlapping arrangement is constituted by a common and shared axial extent between the first and second axial extents 60, 62. Put another way, the torque converter 12 is nested and subjacent to part of the motor-generator unit 14 in regard to the axial direction. The cover 37 and the first set of end-turns 46 exhibit a similar overlapping axial arrangement, as evidenced by the FIGURE, such that a third axial extent 63 of the cover 37 overlaps partially or more with the first axial extent 60 of the first set of end-turns 46. In contrast, a fourth axial extent 64 of the turbine 32 does not axially overlap with the first axial extent 60 of the first set of end-turns 46. Rather, the turbine 32 and the first set of end-turns 46 are offset and spaced axially apart from each other. Likewise, the central region 58 is spaced axially apart from both of the turbine 32 and the impeller 30, and therefore lacks an axially overlapping arrangement with the components and with the second axial extent 62. The rotor 42 too is spaced axially apart from both of the turbine 32 and the impeller 30, and lacks an axially overlapping arrangement with the components and with the second axial extent 62.

In different embodiments, the clutch 38 of the torque converter 12 exhibits a similar axial relationship with the motor-generator unit 14 as described with the impeller 30. As illustrated in the FIGURE, the clutch 38 axial overlaps with the first axial extent 60 of the first set of end-turns 46. And both of the central region 58 and the rotor 42 are spaced axially apart from the clutch 38, and therefore an axially overlapping arrangement is absent and lacking therebetween.

In addition to these axial relationships, the components of the torque converter 12 and motor-generator unit 14 can possess or lack certain radial relationships in different embodiments. The stator 44 is situated at a location that is radially outboard of the torque converter 12. More specifically, the first set of end-turns 46 and the central region 58 are situated at a location that is radially outboard of the impeller 30 and of the turbine 32. The first set of end-turns 46 and the central region 58 are also situated at a location that is radially outboard of the housing 36 and of the cover 37. In other words, the stator 44 and its components are offset and spaced radially apart from the torque converter 12 and its components, and therefore the components lack a radially overlapping arrangement relative to one another. Likewise, the location of the stator 44 is radially outboard of the clutch 38. As before, the first set of end-turns 46 and the central region 58 are situated at a location that is radially outboard of the clutch 38. The stator 44 and its components are offset and spaced radially apart from the clutch 38, and therefore the components lack a radially overlapping arrangement relative to each other. Furthermore, the rotor 42 and the torque converter 12 are arranged relative to each other to exhibit a radial overlapping relationship. A first radial extent 66 of the rotor 42 overlaps with a second radial extent 68 of the impeller 30 in the radial direction. The overlapping relationship is constituted by a common and shared radial extent between the first and second radial extents 66, 68. The radial overlapping relationship also holds true for the rotor 42 and the turbine 32.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A parallel hybrid electric vehicle (HEV) powertrain assembly, comprising:
a torque converter including an impeller, a turbine, and a cover; and
a motor-generator unit (MGU) including a rotor and a stator, the stator having wire windings with a first set of end-turns at one end of the stator;
wherein, in installation of the parallel hybrid electric vehicle powertrain assembly, the first set of end-turns of the stator is situated at a location that is radially outboard of the impeller of the torque converter and of the turbine of the torque converter, and a first axial extent of the first set of end-turns of the stator exhibits an at least partially axially overlapping relationship with a second axial extent of the cover of the torque converter.

2. The parallel hybrid electric vehicle (HEV) powertrain assembly of claim 1, wherein the first axial extent of the first set of end-turns of the stator exhibits an at least partially axially overlapping relationship with a third axial extent of the impeller of the torque converter.

3. The parallel hybrid electric vehicle (HEV) powertrain assembly of claim 1, wherein a fourth axial extent of the turbine of the torque converter lacks an axially overlapping relationship with the first axial extent of the first set of end-turns of the stator.

4. The parallel hybrid electric vehicle (HEV) powertrain assembly of claim 2, wherein the stator has a central region situated axially-inward of the first set of end-turns of the stator and axially-outward of a second set of end-turns of the stator, the central region lacking an axially overlapping relationship with the third axial extent of the impeller of the torque converter.

5. The parallel hybrid electric vehicle (HEV) powertrain assembly of claim 1, wherein a first radial extent of the impeller of the torque converter exhibits a radially overlapping relationship with a second radial extent of the rotor of the motor-generator unit.

6. The parallel hybrid electric vehicle (HEV) powertrain assembly of claim 2, wherein the rotor lacks an axially overlapping relationship with the third axial extent of the impeller of the torque converter.

7. The parallel hybrid electric vehicle (HEV) powertrain assembly of claim 1, wherein the torque converter includes a clutch, the clutch exhibiting an axially overlapping relationship with the first axial extent of the first set of end-turns of the stator.

8. The parallel hybrid electric vehicle (HEV) powertrain assembly of claim 7, wherein the location of the first set of end-turns of the stator is radially outboard of the clutch.

9. The parallel hybrid electric vehicle (HEV) powertrain assembly of claim 1, wherein the location of the first set of end-turns of the stator is radially outboard of the cover of the torque converter.

10. A parallel hybrid electric vehicle (HEV) powertrain assembly, comprising:
a torque converter including an impeller; and
a motor-generator unit (MGU) including a stator, the stator having wire windings with a first set of end-turns at one end of the stator and with a second set of end-turns at an opposite end of the stator, the stator having a central region situated axially-inward of the first set of end-turns and situated axially-outward of the second set of end-turns;
wherein, in installation of the parallel hybrid electric vehicle powertrain assembly, a first axial extent of the first set of end-turns of the stator exhibits an at least partially axially overlapping relationship with a second axial extent of the impeller of the torque converter, and the central region of the stator lacks an axially overlapping relationship with the second axial extent of the impeller of the torque converter.

11. The parallel hybrid electric vehicle (HEV) powertrain assembly of claim 10, wherein the first set of end-turns of the stator is situated at a location that is radially outboard of the impeller of the torque converter.

12. The parallel hybrid electric vehicle (HEV) powertrain assembly of claim 10, wherein a third axial extent of a turbine of the torque converter lacks an axially overlapping relationship with the first axial extent of the first set of end-turns of the stator.

13. The parallel hybrid electric vehicle (HEV) powertrain assembly of claim 10, wherein a first radial extent of the impeller of the torque converter exhibits a radially overlapping relationship with a second radial extent of a rotor of the motor-generator unit.

14. The parallel hybrid electric vehicle (HEV) powertrain assembly of claim 10, wherein a rotor of the motor-generator unit lacks an axially overlapping relationship with the second axial extent of the impeller of the torque converter.

15. The parallel hybrid electric vehicle (HEV) powertrain assembly of claim 10, wherein the torque converter includes a clutch, the clutch exhibiting an axially overlapping relationship with the first axial extent of the first set of end-turns of the stator.

16. A parallel hybrid electric vehicle (HEV) powertrain assembly, comprising:
a torque converter including an impeller; and
a motor-generator unit (MGU) including a rotor and a stator, the stator having wire windings with a first set of end-turns at one end of the stator;
wherein, in installation of the parallel hybrid electric vehicle powertrain assembly, a first axial extent of the first set of end-turns of the stator exhibits an at least partially axially overlapping relationship with a second axial extent of the impeller of the torque converter, and the rotor lacks an axially overlapping relationship with the second axial extent of the impeller of the torque converter.

17. The parallel hybrid electric vehicle (HEV) powertrain assembly of claim 16, wherein the first set of end-turns of the stator is situated at a location that is radially outboard of the impeller of the torque converter.

18. The parallel hybrid electric vehicle (HEV) powertrain assembly of claim 17, wherein a third axial extent of a turbine of the torque converter lacks an axially overlapping relationship with the first axial extent of the first set of end-turns of the stator.

19. The parallel hybrid electric vehicle (HEV) powertrain assembly of claim 18, wherein the torque converter includes a clutch, the clutch exhibiting an axially overlapping relationship with the first axial extent of the first set of end-turns of the stator.

20. The parallel hybrid electric vehicle (HEV) powertrain assembly of claim 19, wherein the location of the first set of end-turns of the stator is radially outboard of the clutch.
